(19) United States
(12) Patent Application Publication
(10) Pub. No.: US 2006/0273887 A1
(43) Pub. Date: Dec. 7, 2006

(54) Radio Communication System and Radio Communication Device

(75) Inventor: Hiroya Yamamoto, Gunma-ken (JP)

Correspondence Address: Gregory A. Walters;FISH & RICHARDSON P.C., P.O. BOX 1022, MINNEAPOLIS, MN, 55440-1022, US

(73) Assignee: Sanyo Electric Co., Ltd, Osaka (JP)

(21) Appl. No.: 11/383,415

(22) Filed: May 15, 2006

(30) Foreign Application Priority Data
May 16, 2005 (JP) 2005-142384

(51) Int. Cl. B60R 25/10

(52) U.S. Cl. 340/426.36; 340/426.23

(57) ABSTRACT

A first radio communication device transmits a first radio signal; a second radio communication device receives the first radio signal; the second radio communication device measures the signal strength of the first radio signal; the second radio communication device transmits the second radio signal containing the signal strength measurement measured by a signal strength measuring section; the first radio communication device receives the second radio signal; and the first radio communication device stores a threshold value set for an individual vehicle in which the first radio communication device is mounted and compares the signal strength measurement contained in the received second radio signal with the threshold value, thereby determining the distance between the first and second radio communication devices.

### CROSS-REFERENCE TO RELATED APPLICATIONS

The present application claims priority from Japanese Patent Application No. 2005-142384 filed on May 16, 2005, which is herein incorporated by reference.

### BACKGROUND OF THE INVENTION

1. Field of the Invention

The present invention relates to a radio communication system and a radio communication device capable of realizing a keyless entry system to be produced with good productivity.

2. Description of the Related Art

Keyless entry systems that enable locking/unlocking of the doors of vehicles by remote operation via a mobile device being carried by the users (carrier) of the vehicles are known. Furthermore, smart entry systems that lock/unlock doors without the operation of a mobile device are known.

Japanese Patent Application Laid-Open Publication No. H05-106376 describes a keyless entry system having a vehicle-mounted radio device (hereinafter called a vehicle-mounted device) and a mobile radio device (hereinafter called a mobile device), wherein the vehicle-mounted device transmits a code request signal at given time intervals, and the mobile device receives the code request signal and transmits a return code and wherein when receiving the return code, the vehicle-mounted device outputs a signal to unlock the doors of the vehicle and, if receiving no return code at all, after a predetermined time elapses, outputs a signal to lock the doors of the vehicle.

Moreover, Japanese Patent Application Laid-Open Publication No. S63-1765 describes technology in which to transmit a call signal to a mobile device, receive an identification code signal from the mobile device, match this identification code signal against an internal code and, if matching, allow the unlocking of a steering lock mechanism, the switching of an ignition switch, the switching of an accessory switch, etc.

Keyless entry systems usually enable or disable the ignition operation of the vehicle and unlock or lock the doors depending on whether or not the mobile device is located within a predetermined distance from the vehicle-mounted device. For example, a keyless entry system that controls the ignition switch of a vehicle enables the ignition operation if the mobile device is located inside a predetermined range from the vehicle-mounted device, and disables the ignition operation if the mobile device is located outside the predetermined range.

When the above control is performed, if the carrier intentionally performs the ignition operation, the ignition operation needs to be reliably performed. On the other hand, while the carrier is away from the vehicle, the system needs to prohibit the ignition operation from being done, e.g., by a child or another person without permission and not according to the carrier's will. Accordingly, the keyless entry system needs to accurately distinguish, for example, whether the mobile device is located inside or outside the predetermined range.

The above distinguishing can be performed by adjusting the power of radio waves that are transmitted from the vehicle-mounted device, for example, such that if being outside the predetermined range, the mobile device cannot receive radio waves transmitted from the vehicle-mounted device, while if being inside the predetermined range, the mobile device can receive radio waves from the vehicle-mounted device. The above power adjustment can be performed by adjusting the resistance of a resistor in the path of an LC resonance circuit forming part of the transmitter of the vehicle-mounted device.

However, in order to adjust the resistance of the resistor, minute work of attaching/detaching a fine resistor to/from a small circuit board is required. Furthermore, since the resistance varies depending on the size, shape and the like of the vehicle, it has to be adjusted individually on a per vehicle type basis. As such, the adjustment of the transmit power is bothersome work, thus decreasing productivity in producing vehicle-mounted devices.

### SUMMARY OF THE INVENTION

The present invention was made in view of the above background, and an object thereof is to provide a radio communication system and radio communication device capable of realizing a keyless entry system to be produced with good productivity.

According to a main aspect of the present invention to achieve the above object, there is provided a radio communication system comprising a first radio communication device that is mounted on a vehicle, including a CPU; a memory; a transmitter that transmits a first radio signal; and a receiver that receives a second radio signal; and a second radio communication device that is carried by a carrier, including a CPU; a memory; a transmitter that transmits the second radio signal; a receiver that receives the first radio signal; and a signal strength measuring section that measures a signal strength of the first radio signal, wherein the first radio communication device transmits the first radio signal, the second radio communication device receives the first radio signal, the second radio communication device measures the signal strength of the first radio signal, the second radio communication device transmits the second radio signal containing the signal strength measurement, the first radio communication device receives the second radio signal, the first radio communication device stores a threshold value to be compared with the signal strength measurement which is set for an individual vehicle in which the first radio communication device is mounted, and the first radio communication device compares the signal strength measurement contained in the received second radio signal with the threshold value, thereby determining the distance between the first radio communication device and the second radio communication device.

In the radio communication system of the present invention, the first radio communication device (vehicle-mounted device) has a threshold value set for the individual vehicle stored therein, and by comparing the S-value of an S-value request signal measured on the second radio communication device (mobile device) side with the threshold value, the distance between the vehicle-mounted device and the mobile device is determined. Hence, only work needed when shipping the vehicle-mounted device is to store a threshold value prepared for an individual vehicle in memory. Thus, work of attaching/detaching a resistor to/from its circuit board so as to adjust the power of radio waves that are transmitted from the vehicle-mounted device is not necessary like in the conventional art, and thus the vehicle-mounted device can be manufactured efficiently.

Further, according to another main aspect of the present invention, there is provided a radio communication system comprising a first radio communication device that is mounted on a vehicle, including a CPU; a memory; a transmitter that transmits a first radio signal; and a receiver that receives a second radio signal; and a second radio communication device that is carried by a carrier, including a CPU; a memory; a transmitter that transmits the second radio signal; a receiver that receives the first radio signal; and a signal strength measuring section that measures a signal strength of the first radio signal, wherein the first radio communication device transmits the first radio signal, the second radio communication device receives the first radio signal, the second radio communication device measures the signal strength of the first radio signal, the second radio communication device transmits the second radio signal containing the signal strength measurement, the first radio communication device stores plural threshold values for the respective types of vehicles in association with respective vehicle identifying information that identify the types of the vehicles, which values are to be compared with the signal strength measurement, the first radio communication device stores the vehicle identifying information of the vehicle in which the first radio communication device is mounted, and the first radio communication device compares the signal strength measurement contained in the second radio signal received with the stored threshold value corresponding to the vehicle identifying information of the vehicle in which the first radio communication device is mounted, thereby determining the distance between the first radio communication device and the second radio communication device.

In the radio communication system of the present invention, a plurality of threshold values for the respective types of vehicles to be compared with the signal strength are stored in association with respective vehicle identifying information that identify the types of the vehicles in the vehicle-mounted device, and the vehicle-mounted device compares the signal strength with the threshold value corresponding to vehicle identifying information of the vehicle in which the vehicle-mounted device is mounted, thereby determining the distance between the vehicle-mounted device and the mobile device. Hence, with the radio communication system of the invention, when producing the vehicle-mounted device, the type of vehicle in which the vehicle-mounted device is to be mounted does not need to be already known. Furthermore, when producing the vehicle-mounted device, the S-value threshold value for the type of vehicle in which an individual vehicle-mounted device is to be mounted does not need to be selected and stored. Moreover, it is easy to remove and install the vehicle-mounted device in another vehicle afterwards.

Features and objects of the present invention other than the above will become apparent from the description of this specification and the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a diagram showing schematically the configuration of a smart keyless entry system 100 according to an implementation of the present invention;

FIG. 2 is a diagram showing the hardware configuration of a vehicle-mounted device 1 according to the implementation of the present invention;

FIG. 3 is a diagram showing the hardware configuration of a mobile device 2 according to the implementation of the present invention;

FIG. 4 is a diagram showing an example of an RSSI circuit 28 according to the implementation of the present invention;

FIG. 5A is a flow chart for explaining the operation of the smart keyless entry system 100 according to the implementation of the present invention;

FIG. 5B is a flow chart for explaining the operation of the smart keyless entry system 100 according to the implementation of the present invention;

FIG. 6 is a timing chart for explaining the operation of the smart keyless entry system 100 according to the implementation of the present invention; and

FIG. 7 is a diagram for explaining another implementation of the present invention.

### DETAILED DESCRIPTION OF THE INVENTION

At least the following matters will be made clear by the explanation in the present specification and the description of the accompanying drawings.

An implementation of the present invention will be described below in detail. In the description below, a smart keyless entry system 100 will be described as an example of a radio communication system according to the invention.

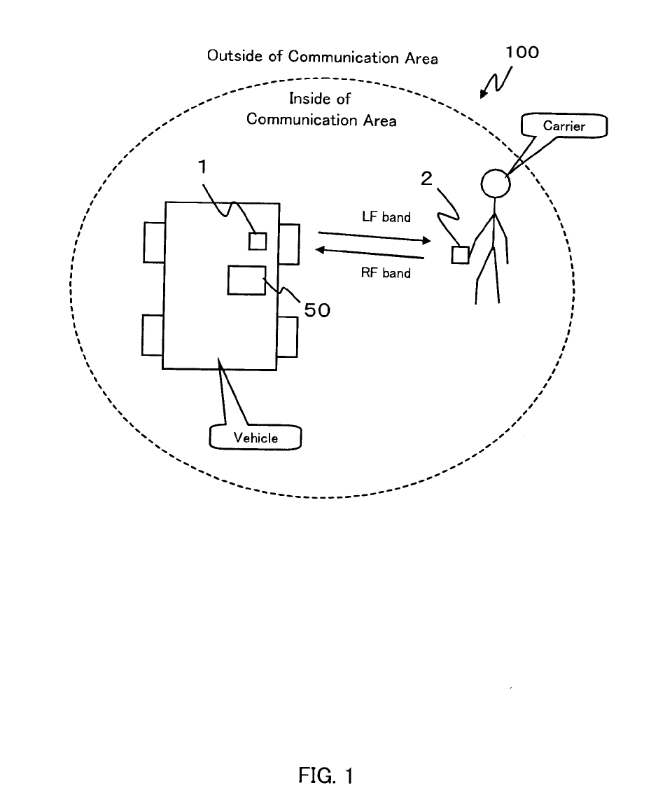

FIG. 1 illustrates schematically the configuration of the smart keyless entry system 100 of the present implementation. The smart keyless entry system 100 comprises a first radio communication device (hereinafter called a vehicle-mounted device 1) mounted in a car as an example of the vehicle in the invention and a second radio communication device (hereinafter called a mobile device 2) incorporated, e.g., in a key to be carried by a carrier such as the car user. The vehicle-mounted device 1 is connected to an apparatus (hereinafter called a controller 50) that performs control related to the ignition switch of the car and to the locking/unlocking of the doors of the car.

In the smart keyless entry system 100 of the present implementation, a signal instructing to enable or disable the ignition operation of the car depending on the distance between the vehicle-mounted device 1 and the mobile device 2 is input to the controller, and the vehicle-mounted device 1 controls the controller 50 according to the above signal received, thereby automatically switching between a state where the ignition operation is enabled and a state where the ignition operation is prohibited. Furthermore, the vehicle-mounted device 1 receives a signal transmitted from the mobile device 2 and controls the controller 50 according to the received signal, thereby automatically locking/unlocking the doors of the car.

In the description below, the ignition operation includes at least one of the operation of the locking/unlocking a steering lock, the operation of switching on/off an accessory switch, and the operation of starting/stopping the engine of the car.

Moreover, in the description below, it is assumed that communication from the vehicle-mounted device 1 to the mobile device 2 is performed via ASK-modulated signals. As such, the ASK-modulation is used in communication from the vehicle-mounted device 1 to the mobile device 2, thereby simplifying the circuit configuration. Also, it is assumed that communication from the mobile device 2 to the vehicle-mounted device 1 is performed via FSK-modulated signals. As such, the FSK-modulation is used in communication from the mobile device 2 to the vehicle-mounted device 1, and thereby information can be transmitted with high quality from the mobile device 2 to the vehicle-mounted device 1 with suppressing the effects of noise. The modulation methods to be used in communication from the vehicle-mounted device 1 to the mobile device 2 and from the mobile device 2 to the vehicle-mounted device 1 are not limited to these. For example, other modulation methods such as spread spectrum modulation can be used.

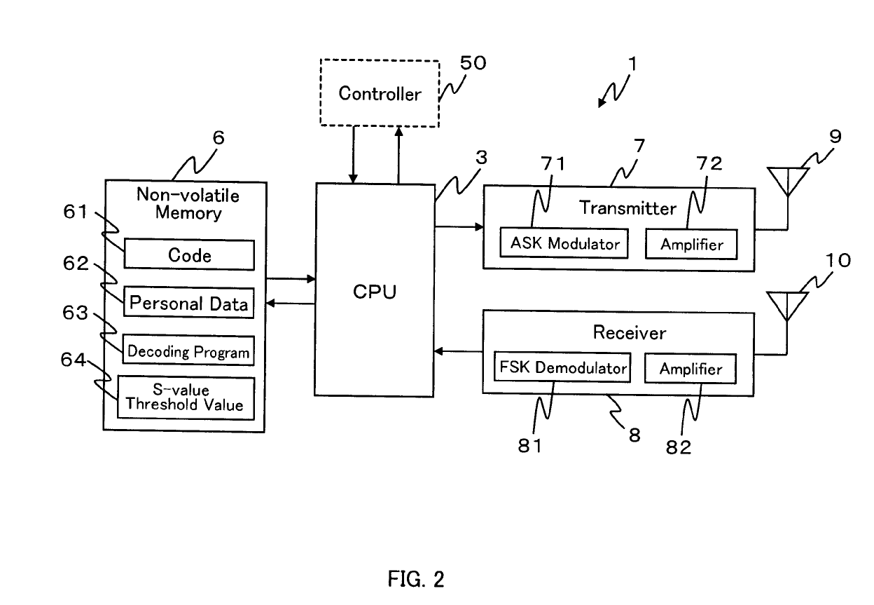

FIG. 2 illustrates the hardware configuration of the vehicle-mounted device 1 according to the implementation of the present invention. The vehicle-mounted device 1 comprises a CPU 3, a non-volatile memory 6 such as a flash memory, a transmitter 7, a receiver 8, a transmit antenna 9, and a receive antenna 10.

The CPU 3 controls the constituents of the vehicle-mounted device 1 overall. Also, the CPU 3 executes programs stored in the non-volatile memory 6, thereby implementing various functions.

One of the above programs stored in the memory 6 to be executed by the CPU 3 is a decoding program 63 for decoding encrypted personal data received from the mobile device 2. Also, stored in the non-volatile memory 6 are a code 61 and personal data 62 to be used in authenticating data coming in from the mobile device 2 and a threshold value 64 for an S-value to be used in determining the distance between the vehicle-mounted device 1 and the mobile device 2.

The transmitter 7 comprises an ASK modulator 71 that outputs a transmit signal which a signal sent from the CPU 3 has been ASK-modulated (Amplitude Shift Keying Modulate) into with a carrier wave of low frequency (e.g. 125 kHz), an amplifier 72 that amplifies the transmit signal, and a transmit antenna 9 via which the amplified transmit signal is transmitted by radio.

The receiver 8 comprises a receive antenna 10 that receives radio signals, an amplifier 82 that amplifies the received signal from the receive antenna 10, and an FSK demodulator 81 that inputs a demodulated signal produced by demodulating the received, FSK-modulated (Frequency Shift Keying Modulate) signal to the CPU 3.

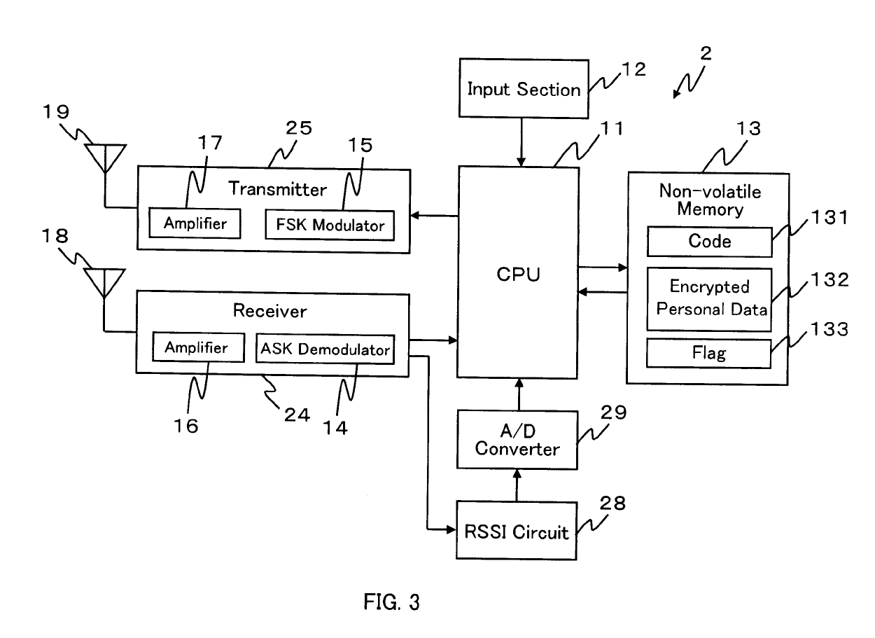

FIG. 3 illustrates the hardware configuration of the mobile device 2 according to the implementation of the present invention. The mobile device 2 comprises a CPU 11, an input section 12, a non-volatile memory 13 such as a flash memory, a receiver 24, a transmitter 25, a receive antenna 18, a transmit antenna 19, an RSSI circuit 28, and an A/D converter 29.

The CPU 11 controls the constituents of the mobile device 2 overall. Also, the CPU 11 executes programs stored in the non-volatile memory 13, thereby implementing various functions.

Stored in the non-volatile memory 13 are a code 131 and encrypted personal data 132, which are to be transmitted to the vehicle-mounted device 1 for authentication in this device, and a flag 133 indicating the content of the operation instruction inputted to the input section 12.

The transmitter 25 comprises an FSK modulator 15 that outputs a transmit signal which a signal sent from the CPU 11 has been FSK-modulated into with a carrier wave of high frequency (e.g., 312 MHz in an ultrahigh frequency (UHF) band), an amplifier 17 that amplifies the transmit signal, and a transmit antenna 19 via which the amplified transmit signal is transmitted by radio.

The receiver 24 comprises a receive antenna 18 via which radio signals are received, an amplifier 16 that amplifies the received signal input from the receive antenna 18, and an ASK demodulator 14 that inputs a demodulated signal produced by demodulating the received, ASK-modulated signal to the CPU 11.

The input section 12 accepts the operation instruction input by the carrier to do an operation such as the ignition operation or the lock/unlock operation of the doors and inputs a signal that corresponds to the operation instruction input to the CPU 11.

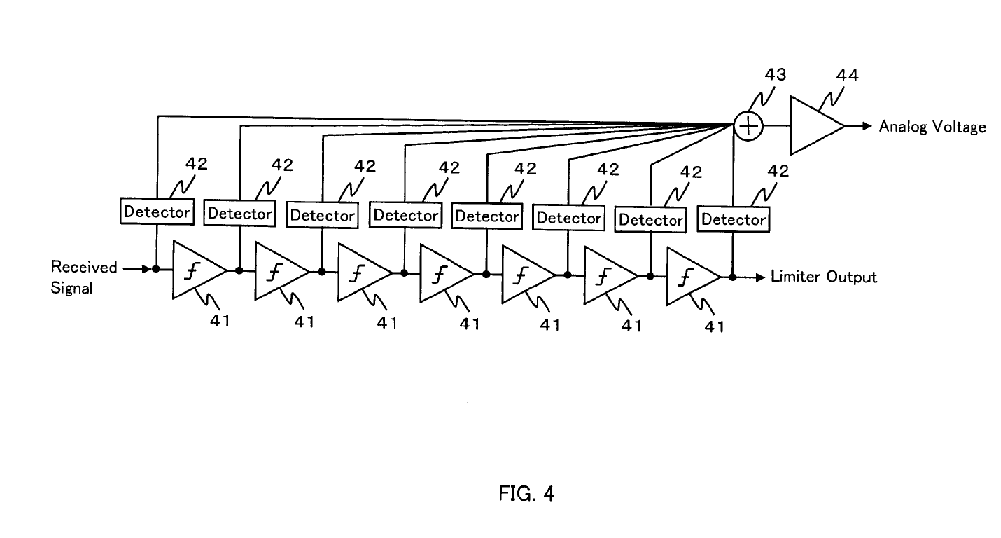

The RSSI (Received Signal Strength Indicator) circuit 28 (a signal strength measuring section) outputs in the form of an analog voltage the strength of the received signal input via the receive antenna 18 (hereinafter called an S-value). An AGC (Automatic Gain Control) voltage of the ASK demodulator 14, for example, is input to the RSSI circuit 28. FIG. 4 shows an example of the RSSI circuit 28. The RSSI circuit shown in the Figure comprises plural stages of limiter amplifiers 41, plural detectors 42 that detect the outputs of the respective limiter amplifiers 41, an adder 43 that adds the output voltages of the detectors 42, and an amplifier 44. The RSSI circuit of the Figure outputs the sum of the respective output voltages of the detectors 42 in the form of the analog voltage indicating the signal strength.

The analog voltage indicating the signal strength output from the RSSI circuit 28 is converted by the A/D converter 29 into a digital value and supplied to the CPU 11.

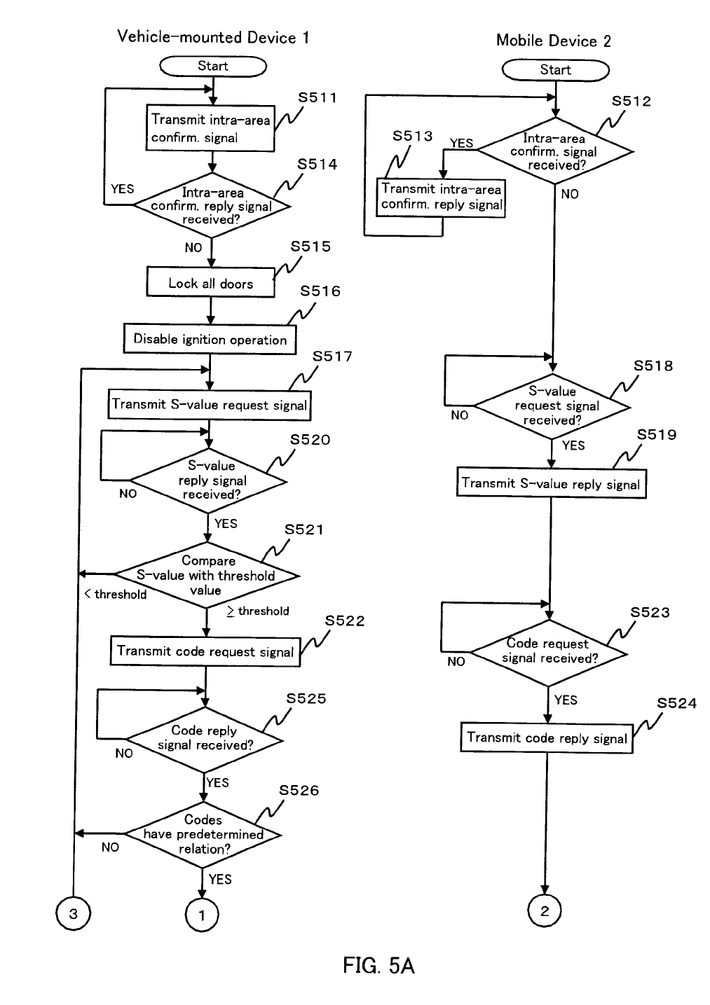

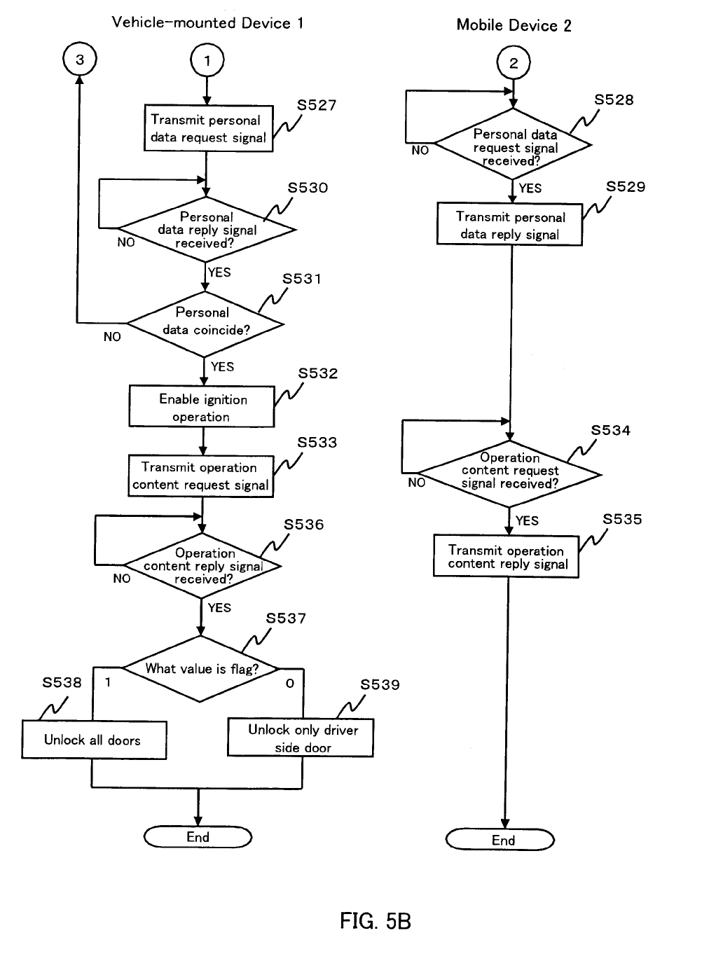

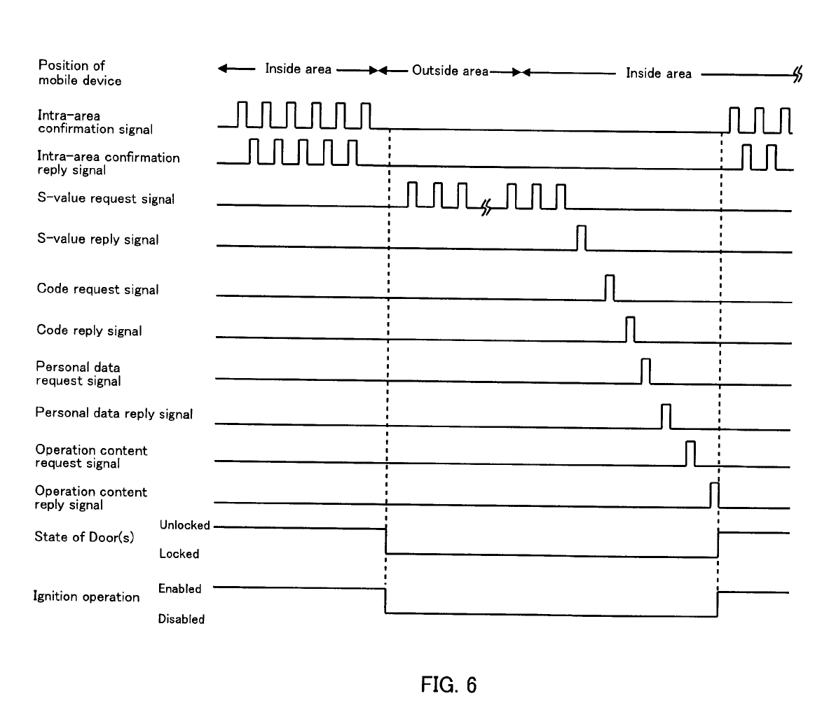

Next, the specific operation of the smart keyless entry system 100 according to the implementation of the present invention will be described with reference to the flow chart shown in FIGS. 5A and 5B and the timing chart shown in FIG. 6. Note that the flow chart shown in FIGS. 5A and 5B describes the process starting from the scene that after stopping the car engine through the ignition operation, the carrier carrying the mobile device 2 has got off the car and just closed the door.

First, when the door is closed, the controller 50 detects that and inputs a signal indicating that to the CPU 3 of the vehicle-mounted device 1. When the signal is input, the CPU 3 of the vehicle-mounted device 1 controls the transmitter 7 to start transmitting a radio signal (fifth radio signal; hereinafter called an intra-area confirmation signal) to confirm whether the mobile device 2 is within a predetermined area (S511). Note that this intra-area confirmation signal is transmitted repeatedly at predetermined intervals thereafter. The intra-area confirmation signal (fifth radio signal) is a signal into which a carrier wave of a frequency in a low frequency band (e.g., 125 kHz in a long wave (LF) band) has been ASK-modulated.

Here, if the mobile device 2 is within the range in which it can receive the intra-area confirmation signal (hereinafter called a communication area), the mobile device 2 can receive the intra-area confirmation signal (fifth radio signal) transmitted from the vehicle-mounted device 1. The intra-area confirmation signal (fifth radio signal) received by the mobile device 2 is amplified by the amplifier 16 and demodulated by the ASK demodulator 14. The demodulated signal is input to the CPU 11.

The CPU 11 of the mobile device 2 monitors in real time whether the intra-area confirmation signal (fifth radio signal) has been input (S512). When detecting that the demodulated signal has been input (S512: YES), the CPU 11 of the mobile device 2 controls the transmitter 25 to transmit a radio signal (sixth radio signal; hereinafter called an intra-area confirmation reply signal) in reply to the intra-area confirmation signal (S513). The intra-area confirmation reply signal (sixth radio signal) is a signal into which a carrier wave of a frequency in a high frequency band (e.g., 312 MHz in an ultrahigh frequency (UHF) band) has been FSK-modulated.

When the mobile device 2 is within the communication area, the vehicle-mounted device 1 receives the intra-area confirmation reply signal (sixth radio signal) transmitted from the mobile device 2. The received intra-area confirmation reply signal (sixth radio signal) is amplified by the amplifier 82 of the vehicle-mounted device 1 and then demodulated by the FSK demodulator 81. The demodulated signal is input to the CPU 3. The CPU 3 of the vehicle-mounted device 1 monitors in real time whether the intra-area confirmation reply signal (sixth radio signal) has been input (S514). When detecting that the demodulated signal has been input (S514: YES), the CPU 3 of the vehicle-mounted device 1 controls the transmitter 7 to transmit the intra-area confirmation signal (fifth radio signal) again (S511).

As such, the vehicle-mounted device 1 monitors in real time whether the mobile device 2 is located within the communication area by detecting whether the intra-area confirmation reply signal (sixth radio signal) has been returned in reply to the transmitted intra-area confirmation signal (fifth radio signal). While it continues to determine that the mobile device 2 is within the communication area, the ignition operation of the car is enabled and the doors of the car are unlocked.

If the intra-area confirmation reply signal (sixth radio signal) is not received within a predetermined time after transmitting the intra-area confirmation signal (fifth radio signal) (S514: NO), the CPU 3 of the vehicle-mounted device 1 inputs a signal to instruct to lock all doors of the car to the controller 50. Thus, all doors of the car are locked (S515). Also, the CPU 3 of the vehicle-mounted device 1 inputs a signal to instruct to prohibit the ignition operation of the car to the controller 50 (S516).

Instead of locking the doors immediately when it is determined that the intra-area confirmation reply signal (sixth radio signal) has not been received within the predetermined time, only when the intra-area confirmation reply signal (sixth radio signal) is not received while the intra-area confirmation signal (fifth radio signal) is transmitted a predetermined number of times, the doors of the car may be locked. In this way, the vehicle-mounted device 1 can reliably determine that the mobile device 2 is not within the communication area. Furthermore, there may be cases where, immediately after going outside the communication area, the carrier returns inside the communication area, but in these cases, the carrier does not need to unlock the doors.

Next, the CPU 3 of the vehicle-mounted device 1 controls the transmitter 7 to transmit a signal to request the receive signal strength (S-value) (hereinafter called an S-value request signal) (S517). Note that the S-value request signal is transmitted at predetermined intervals. The S-value request signal is a signal into which a carrier wave of a frequency in a low frequency band (e.g., 125 kHz in a long wave (LF) band) has been ASK-modulated.

Next, when the mobile device 2 moves inside the communication area as the carrier approaches the car again, the mobile device 2 receives the S-value request signal transmitted from the vehicle-mounted device 1 (S518). The S-value request signal received by the mobile device 2 is demodulated by the receiver 24. The demodulated signal is input to the CPU 11. At the same time, the AGC voltage output from the ASK demodulator 14 in the demodulation of the S-value request signal is input to the RSSI circuit 28, and the A/D converter 29 inputs digital data indicating the signal strength of the S-value request signal to the CPU 11.

After coming to be unable to receive the intra-area confirmation signal (fifth radio signal) (S512: NO), the CPU 11 of the mobile device 2 starts monitoring in real time whether the S-value request signal has been input (S518). When detecting that the S-value request signal has been input (S518: YES), the CPU 11 of the mobile device 2 controls the transmitter 25 to transmit a signal containing data indicating the signal strength of the S-value request signal (hereinafter called an S-value reply signal) (S519). The S-value reply signal is a signal into which a carrier wave of a frequency in a high frequency band (e.g., 312 MHz in an ultrahigh frequency (UHF) band) has been FSK-modulated.

Next, the S-value reply signal is received by the vehicle-mounted device 1 and amplified by the amplifier 82 and then demodulated by the FSK demodulator 81. The demodulated signal is input to the CPU 3. The CPU 3 of the vehicle-mounted device 1 monitors in real time whether the S-value reply signal has been input (S520). When detecting that the S-value reply signal has been input (S520: YES), the CPU 3 of the vehicle-mounted device 1 compares the S-value contained in the demodulated signal and the threshold value 64 for S-values stored in the non-volatile memory 6 (S521). Here, the S-value threshold value 64 is set to an S-value actually measured by the mobile device 2 when the mobile device 2 is located on the boundary between the inside and outside of the car. By setting the S-value threshold value 64 to such a value, it can be accurately determined whether the mobile device 2 is located inside or outside the car. Thus, for example, the ignition operation not according to the carrier's will is prevented.

If the S-value contained in the demodulated signal is smaller than the S-value threshold value 64 (S521: being below the threshold), process returns to S517. On the other hand, if the S-value contained in the demodulated signal is at or above the S-value threshold value 64 (S521: being at or above the threshold), the CPU 3 controls the transmitter 7 to transmit a signal to request the sending of the code (hereinafter called a code request signal) to the mobile device 2 (S522). This code request signal is a signal into which a carrier wave of a frequency in a low frequency band (e.g., 125 kHz in a long wave (LF) band) has been ASK-modulated.

Then, the mobile device 2 receives the code request signal transmitted by the vehicle-mounted device 1. The code request signal received by the mobile device 2 is amplified by the amplifier 16 and demodulated by the ASK demodulator 14. The demodulated signal is input to the CPU 11.

The CPU 11 of the mobile device 2 monitors in real time whether the code request signal has been input (S523). When detecting that the code request signal has been input (S523: YES), the CPU 11 of the mobile device 2 controls the transmitter 25 to transmit a signal containing the code 61 that has been stored in the non-volatile memory 13 (hereinafter called a code reply signal) (S524). The code reply signal is a signal into which a carrier wave of a frequency in a high frequency band (e.g., 312 MHz in an ultrahigh frequency (UHF) band) has been FSK-modulated.

The code reply signal is received by the vehicle-mounted device 1 and amplified by the amplifier 82 and then demodulated by the FSK demodulator 81. The demodulated signal is input to the CPU 3. The CPU 3 of the vehicle-mounted device 1 monitors in real time whether the code reply signal has been input (S525). When detecting that the code reply signal has been input (S525: YES), the CPU 3 of the vehicle-mounted device 1 determines whether the code contained in the demodulated signal and the code 61 stored in the non-volatile memory 6 have a predetermined relationship with each other (e.g., coinciding or being in a relationship where the value of one is calculated from the value of the other according to a predetermined function) (S526). If the two have a predetermined relationship (S526: YES), the CPU 3 of the vehicle-mounted device 1 controls the transmitter 7 to transmit a signal to request personal data (hereinafter called a personal data request signal) (S527). On the other hand, if the two do not have a predetermined relationship (S526: NO), process returns to S517, where the S-value request signal is transmitted again.

Then, the personal data request signal is received by the mobile device 2 and amplified by the amplifier 16 and then demodulated by the ASK demodulator 14. The demodulated signal is input to the CPU 11. The CPU 11 of the mobile device 2 monitors in real time whether the personal data request signal has been input (S528). When detecting that the demodulated signal has been input (S528: YES), the CPU 11 of the mobile device 2 controls the transmitter 25 to transmit a signal containing encrypted personal data 132 that has been stored in the non-volatile memory 13 (hereinafter called a personal data reply signal) (S529). The personal data reply signal is a signal into which a carrier wave of a frequency in a high frequency band (e.g., 312 MHz in an ultrahigh frequency (UHF) band) has been FSK-modulated.

Then, the personal data reply signal is received by the vehicle-mounted device 1. The received personal data reply signal is amplified by the amplifier 82 and then demodulated by the FSK demodulator 81. The demodulated signal is input to the CPU 3. The CPU 3 of the vehicle-mounted device 1 monitors in real time whether the personal data reply signal has been input (S530). When detecting that the personal data reply signal has been input (S530: YES), the CPU 3 of the vehicle-mounted device 1 decodes the encrypted personal data 132 contained in the demodulated signal and determines whether the decoded personal data and the personal data 62 stored in the non-volatile memory 6 coincide (S531). If the decoded personal data and the personal data 62 stored in the non-volatile memory 6 coincide (S531: YES), the CPU 3 inputs a signal to instruct to enable the ignition operation of the car to the controller 50 (S532). Moreover, the CPU 3 of the vehicle-mounted device 1 controls the transmitter 7 to transmit a signal to request the content of the operation designated by the carrier (hereinafter called an operation content request signal) (S533).

On the other hand, if the decoded personal data and the personal data 62 stored in the non-volatile memory 6 of the vehicle-mounted device 1 do not coincide (S531: NO), process returns to S517, where the S-value request signal is transmitted again.

Next, the mobile device 2 receives the operation content request signal. The received operation content request signal is amplified by the amplifier 16 and then demodulated by the ASK demodulator 14. The demodulated signal is input to the CPU 11. The CPU 11 of the mobile device 2 monitors in real time whether the operation content request signal has been input (S534). When detecting that the demodulated signal has been input (S534: YES), the CPU 11 of the mobile device 2 controls the transmitter 25 to transmit a signal containing the flag 133 that has been stored in the non-volatile memory 13 (hereinafter called an operation content reply signal) (S535).

The operation content reply signal is a signal into which a carrier wave of a frequency in a high frequency band (e.g., 312 MHz in an ultrahigh frequency (UHF) band) has been FSK-modulated. Assume that the flag 133 is set to 1 when the carrier designates the execution of the operation of unlocking the driver side door through the input section 12 and to 0 when the carrier designates the execution of the operation of unlocking all doors through the input section 12.

The operation content reply signal is received by the vehicle-mounted device 1. The received operation content reply signal is amplified by the amplifier 82 and then demodulated by the FSK demodulator 81. The demodulated signal is input to the CPU 3. The CPU 3 of the vehicle-mounted device 1 monitors in real time whether the operation content reply signal has been input (S536). When detecting that the operation content reply signal has been input (S536: YES), the CPU 3 of the vehicle-mounted device 1 examines the value of the flag 133 contained in the demodulated signal (S537). If the value of the flag 133 is at 1 (S537: 1), the CPU 3 of the vehicle-mounted device 1 inputs a signal to instruct to unlock only the driver side door of the car to the controller 50. Thereby, only the driver side door of the car is unlocked (S538). In contrast, if the value of the flag 133 is at 0 (S537: 0), the CPU 3 of the vehicle-mounted device 1 inputs a signal to instruct to unlock all doors to the controller 50. Thereby, all doors of the car are unlocked (S539).

As such, in the smart keyless entry system 100 of the implementation, the vehicle-mounted device 1 has a threshold value set for the individual vehicle stored therein, and by comparing the S-value of the S-value request signal measured on the mobile device 2 side with the threshold value, the distance between the vehicle-mounted device 1 and the mobile device 2 is determined. Hence, for the smart keyless entry system 100 of the implementation, only work needed when shipping the vehicle-mounted device 1 is to store a threshold value prepared for the individual vehicle in memory. Thus, work of attaching/detaching a resistor to/from its circuit board so as to adjust the power of radio waves that are transmitted from the vehicle-mounted device 1 is not necessary like in the conventional art, and thus the vehicle-mounted device can be manufactured efficiently.

Although the preferred implementation of the present invention has been described, the above implementation is provided to facilitate the understanding of the present invention and not intended to limit the present invention. It should be understood that various changes and alterations can be made therein without departing from the spirit and scope of the invention and that the present invention includes its equivalents.

For example, in the implementation described above, when the distance between the vehicle-mounted device 1 and the mobile device 2 becomes a predetermined value, all doors are locked (S515) and the ignition operation is prohibited (S516). However, the values of the distance between the vehicle-mounted device 1 and the mobile device 2 for which these are performed do not necessarily need to coincide. For example, the distance for which all doors are locked may be set longer than the distance for which the ignition operation is prohibited. Also, the distance for which the ignition operation is enabled (S532) and the distance for which the operation content request signal is transmitted (S533) may be different, and the distance for which the ignition operation is enabled may be set shorter than the distance for which the operation content request signal is transmitted.

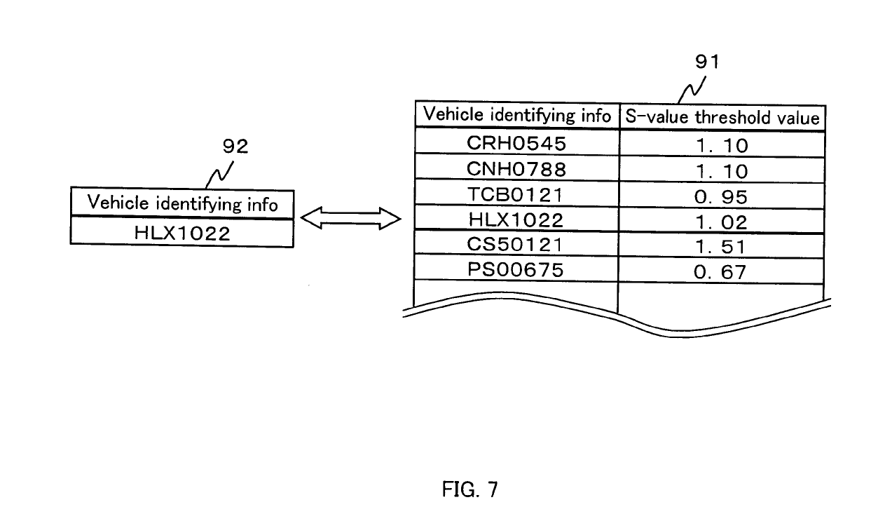

Furthermore, as to the S-value threshold value 64, only its value for the type of vehicle in which the vehicle-mounted device 1 is to be mounted may be stored in the vehicle-mounted device 1, but as shown in FIG. 7, a plurality of S-value threshold values for the respective types of vehicles in association with respective vehicle identifying information that identify the types of the vehicles (denoted by reference numeral 91) may be stored in the non-volatile memory 6 of the vehicle-mounted device 1, e.g., when the vehicle-mounted device 1 is produced so that the vehicle-mounted device 1 automatically selects the S-value threshold value corresponding to vehicle identifying information of the vehicle concerned (denoted by reference numeral 92) stored in the non-volatile memory 6, the controller 50, or the like and compares it with the actual signal strength. By this means, when producing the vehicle-mounted device 1, the type of vehicle in which the vehicle-mounted device 1 is to be mounted does not need to be already known. Furthermore, when producing the vehicle-mounted device 1, the S-value threshold value for the type of vehicle in which the individual vehicle-mounted device 1 is to be mounted does not need to be selected and stored. Moreover, since plural S-value threshold values are stored beforehand in the vehicle-mounted device 1, it is easy to remove and install the vehicle-mounted device 1 in another vehicle afterwards.

What is claimed is:

1. A radio communication system comprising:
a first radio communication device that is mounted on a vehicle, including a CPU; a memory; a transmitter that transmits a first radio signal; and a receiver that receives a second radio signal; and
a second radio communication device that is carried by a carrier, including a CPU; a memory; a transmitter that transmits the second radio signal; a receiver that receives the first radio signal; and a signal strength measuring section that measures a signal strength of the first radio signal, wherein
the first radio communication device transmits the first radio signal,
the second radio communication device receives the first radio signal,
the second radio communication device measures the signal strength of the first radio signal,
the second radio communication device transmits the second radio signal containing the signal strength measurement,
the first radio communication device receives the second radio signal,
the first radio communication device stores a threshold value to be compared with the signal strength measurement which is set for an individual vehicle in which the first radio communication device is mounted, and
the first radio communication device compares the signal strength measurement contained in the received second radio signal with the threshold value, thereby determining the distance between the first radio communication device and the second radio communication device.

2. The radio communication system according to claim 1, wherein the signal strength measuring section is constituted by an RSSI circuit.

3. The radio communication system according to claim 1, wherein the first radio communication device is connected to a controller that controls an ignition operation which includes at least one of an operation of locking or unlocking a steering lock of the vehicle, an operation of switching on/off an accessory switch, and an operation of starting or stopping an engine of the vehicle, and
wherein the first radio communication device transmits to the controller a signal to instruct to set the ignition operation enabled or disabled depending on a result of the determination.

4. The radio communication system according to claim 1, wherein the first radio communication device is connected to a controller that controls locking or unlocking a door, and
wherein the first radio communication device transmits to the controller a signal to instruct to lock or unlock the door depending on a result of the determination.

5. The radio communication system according to claim 1, wherein each said threshold value is set to the signal strength of the first radio signal measured by the second radio communication device when the second radio communication device is located on the boundary between the inside and outside of the corresponding vehicle.

6. A radio communication system comprising:
a first radio communication device that is mounted on a vehicle, including a CPU; a memory; a transmitter that transmits a first radio signal; and a receiver that receives a second radio signal; and
a second radio communication device that is carried by a carrier, including a CPU; a memory; a transmitter that transmits the second radio signal; a receiver that receives the first radio signal; and a signal strength measuring section that measures a signal strength of the first radio signal, wherein
the first radio communication device transmits the first radio signal,
the second radio communication device receives the first radio signal,
the second radio communication device measures the signal strength of the first radio signal,
the second radio communication device transmits the second radio signal containing the signal strength measurement,
the first radio communication device stores plural threshold values for the respective types of vehicles in association with respective vehicle identifying information that identify the types of the vehicles, which values are to be compared with the signal strength measurement,
the first radio communication device stores the vehicle identifying information of the vehicle in which the first radio communication device is mounted, and
the first radio communication device compares the signal strength measurement contained in the second radio signal received with the stored threshold value corresponding to the vehicle identifying information of the vehicle in which the first radio communication device is mounted, thereby determining the distance between the first radio communication device and the second radio communication device.

7. The radio communication system according to claim 6, wherein the signal strength measuring section is constituted by an RSSI circuit.

8. The radio communication system according to claim 6, wherein the first radio communication device is connected to a controller that controls an ignition operation which includes at least one of an operation of locking or unlocking a steering lock of the vehicle, an operation of switching on/off an accessory switch, and an operation of starting or stopping an engine of the vehicle, and
wherein the first radio communication device transmits to the controller a signal to instruct to set the ignition operation enabled or disabled depending on a result of the determination.

9. The radio communication system according to claim 6, wherein the first radio communication device is connected to a controller that controls locking or unlocking a door, and
wherein the first radio communication device transmits to the controller a signal to instruct to lock or unlock the door depending on a result of the determination.

10. The radio communication system according to claim 6, wherein each said threshold value is set to the signal strength of the first radio signal measured by the second radio communication device when the second radio communication device is located on the boundary between the inside and outside of the corresponding vehicle.

11. A radio communication device which is the first radio communication device of the radio communication system of claim 1, comprising:
a CPU; a memory; a transmitter that transmits a first radio signal; and a receiver that receives a second radio signal, the radio communication device
transmitting the first radio signal,
receiving the second radio signal,
storing a threshold value set for an individual vehicle in which the first radio communication device is mounted, and
comparing the signal strength measurement contained in the received second radio signal with the threshold value, thereby determining the distance between the first radio communication device and the second radio communication device.

12. A radio communication device which is the first radio communication device of the radio communication system of claim 6, comprising:
a CPU; a memory; a transmitter that transmits a first radio signal; and a receiver that receives a second radio signal, the radio communication device
transmitting the first radio signal,
storing plural threshold values for the respective types of vehicles in association with respective vehicle identifying information that identify the types of the vehicles, which values are to be compared with the signal strength measurement,
storing the vehicle identifying information of the vehicle in which the first radio communication device is mounted, and
comparing the signal strength measurement contained in the second radio signal received with the stored threshold value corresponding to the vehicle identifying information of the vehicle in which the first radio communication device is mounted, thereby determining the distance between the first radio communication device and the second radio communication device.

13. A radio communication device which is the second radio communication device of the radio communication system of claim 1, comprising:
a CPU; a memory; a transmitter that transmits a second radio signal; a receiver that receives a first radio signal; and a signal strength measuring section that measures a signal strength of the first radio signal, the radio communication device
receiving the first radio signal,
measuring a signal strength of the first radio signal, and
transmitting the second radio signal containing the signal strength measurement.

14. A radio communication device which is the second radio communication device of the radio communication system of claim 6, comprising:
a CPU; a memory; a transmitter that transmits a second radio signal; a receiver that receives a first radio signal; and a signal strength measuring section that measures a signal strength of the first radio signal, the radio communication device
receiving the first radio signal,
measuring a signal strength of the first radio signal, and
transmitting the second radio signal containing the signal strength measurement.
